(19) United States
(12) Patent Application Publication
(10) Pub. No.: US 2023/0211752 A1
(43) Pub. Date: Jul. 6, 2023

(54) ACCESS ARRANGEMENT FOR A VEHICLE

(71) Applicant: Continental Automotive Technologies GmbH, Hannover (DE)

(72) Inventors: Ulrich Emmerling, Kelheim (DE); Alexander Heinrich, Donaustauf (DE)

(73) Assignee: Continental Automotive Technologies GmbH, Hannover (DE)

(21) Appl. No.: 18/008,842

(22) PCT Filed: May 31, 2021
(86) PCT No.: PCT/DE2021/200074

§ 371 Date: Dec. 7, 2022

(30) Foreign Application Priority Data
Jun. 10, 2020 (DE) 10 2020 207 244.2

(51) Int. Cl. B60R 25/24; B60R 25/34; B60R 25/20

(52) U.S. Cl. CPC B60R 25/241; B60R 25/34; B60R 25/209

(57) ABSTRACT

An access arrangement for a vehicle comprises a vehicle transmission/reception device configured to transmit multiple interrogation signals to a mobile identification transmitter, receive corresponding response signals from the mobile identification transmitter in response to the transmitted interrogation signals, and determine a respective time interval that elapsed between the transmission of an interrogation signal and the reception of a corresponding response signal. Furthermore, the access arrangement comprises a vehicle control device configured to output a different control command based on a change in the specific time intervals for two transmitted interrogation signals. The interrogation signals and response signals are in accordance with the UWB standard. Based on the evaluation of the time-of-flight differences of two interrogation signals, it is possible to detect when the mobile identification transmitter changes location or remains at one location, and accordingly to output a different and appropriate control command by the vehicle control device.

The present invention relates to an access arrangement for a vehicle, in particular for a motor vehicle. It also relates to a vehicle having such an access arrangement. Finally, it relates to a method for operating an access arrangement for a vehicle.

In today's modern vehicles, in particular motor vehicles, so-called passive access arrangements are used for access control, in which the vehicle conducts a question-and-answer dialog with an associated mobile identification transmitter of a driver in order to authenticate the driver. A code is automatically transmitted from the identification transmitter to the vehicle without the driver having to operate an operating element of the identification transmitter. If the code transmitted to the vehicle matches a predetermined code, a specific door or all of the doors of the vehicle are unlocked, or opened.

A disadvantage of such access arrangements is that the question-and-answer dialog may be tricked by way of radio link extensions as part of a so-called middleman attack (“relay attack”), and the vehicle may therefore be stolen by thieves.

The object of the present invention is therefore to provide an improved option for passive access to a vehicle that offers more security without loss of comfort for a driver.

This object is achieved by the subjects of the independent claims. Advantageous configurations are covered by the subclaims.

According to a first aspect of the invention, an access arrangement for a vehicle, in particular a motor vehicle, is provided, having the following features.

It has a vehicle transmission/reception device that is configured to transmit multiple interrogation signals to a mobile identification transmitter. In this case, the interrogation signals are transmitted in particular one after the other. Furthermore, the vehicle transmission/reception device is configured to receive corresponding response signals from the mobile identification transmitter in response to the transmitted interrogation signals in order to determine a respective time interval that has elapsed between the transmission of an interrogation signal and the reception of a corresponding response signal. The access arrangement also comprises a vehicle control device for outputting a different control command on the basis of a change in the specific time intervals for in each case two transmitted interrogation signals. A middleman attack may be effectively prevented by using a time-of-flight measurement for a respective interrogation signal from the vehicle and the corresponding response signal from the identification transmitter. In addition, by monitoring the change in the specific time intervals for two transmitted interrogation signals, the vehicle control device is able to react to different situations and applications for the driver carrying the mobile identification transmitter with an appropriate control command.

It is conceivable for the vehicle control device to perform the check on the change in the specific time intervals for in each case two interrogation signals transmitted directly one after the other. However, it is also possible for the vehicle control device to perform the check on the change in the specific time intervals for in each case two transmitted interrogation signals that were not transmitted directly one after the other. This means that the vehicle control device first determines a first time interval between the transmission of a first interrogation signal and the reception of a corresponding response signal and then transmits a specific number of one or more further interrogation signals. The vehicle control device then transmits a second interrogation signal and uses it to determine a second time interval between the transmission of the second interrogation signal and the reception of a corresponding response signal, in order finally to ascertain the change in the first time interval and the second time interval therefrom. This ascertainment of the change in the specific time intervals for in each case two transmitted interrogation signals, which are separated from one another by a specific number of further interrogation signals or a predetermined period of time, is advantageous in particular if the interrogation signals are transmitted in relatively short succession and/or only very slow movements of the mobile identification transmitter are to be expected.

According to one configuration of the access arrangement, the interrogation signals and response signals are signals in accordance with the UWB (ultra-wideband) standard. In this regard, it is accordingly conceivable for the vehicle transmission/reception device, as a UWB transmitter, to send a UWB signal, in particular an encrypted UWB signal, to the mobile identification transmitter. The mobile identification transmitter can then sign the signal and return it in modified form to the vehicle transmission/reception device (now as a UWB receiver). The latter now knows how much time has elapsed between the sending and receiving of the signal and can therefore determine the respective time interval that has elapsed between the transmission of an interrogation signal and the reception of a corresponding response signal. It is furthermore conceivable to then also subtract the envisaged time that the mobile identification transmitter needs for calculating the signature, in order to thus determine the actual time of flight of the interrogation signal and the response signal.

Using the specific time interval, or the actual time of flight of the interrogation signal and the response signal, it is also possible for the vehicle transmission/reception device or the associated vehicle control device to calculate the distance or radius at/within which the mobile identification transmitter is located. If there were provision for multiple UWB transmitters and receivers at different locations in the vehicle, which exchange UWB signals with the mobile identification transmitter, it would also be possible to calculate the exact position of the mobile identification transmitter with respect to the vehicle.

According to one configuration of the access arrangement, the vehicle control device is configured to recognize specific applications and to output applicable control commands. In this regard, it is able to output at least one first control command in the event of a change in the specific time intervals for two transmitted interrogation signals less than or equal to a predetermined threshold value. This means that in this case the vehicle control device recognizes more or less “static” situations in which the mobile identification transmitter does not move or hardly moves, such as during an authentication process for starting the engine or if the mobile identification transmitter is accidentally left in the vehicle or close to the vehicle. In addition or as an alternative to this, the vehicle control device is able to output at least one second control command in the event of a change in the specific time intervals for two transmitted interrogation signals greater than the predetermined threshold value. This means that in this case the vehicle control device recognizes more or less “dynamic” situations in which the mobile identification transmitter moves significantly, such as when moving towards or away from the vehicle.

In particular, when “dynamic” situations are recognized, i.e. when a change in the specific time intervals for two transmitted interrogation signals greater than the predetermined threshold value is detected, which indicates movement towards or away from the vehicle, an unlock command or a lock command may be output by the vehicle control device. To provide a clear definition of which of the two control commands is to be output, it may be specified that only a specific one of the control commands (such as the lock command) is ever output when the change greater than the predetermined threshold value is detected.

It is also conceivable, when a dynamic situation is recognized, to include further parameters in order to bring about goal-oriented output of a suitable control command. It is thus conceivable to use the signal from a locking sensor for sensing an unlocked or locked state of at least one door of the vehicle and/or from a door sensor for sensing an open or closed state of at least one door of the vehicle as a further parameter. It is also conceivable to use the respective time interval that has elapsed between the transmission of an interrogation signal and the reception of a corresponding response signal as a further parameter. In this regard, it is possible to consider the duration of the time interval, which is a measure of the distance traveled by an interrogation signal and a corresponding response signal. Accordingly, the specific time interval may represent the distance between the vehicle transmission/reception device and the mobile identification transmitter. Furthermore, the exact consideration of the change in the time intervals may be used as a further parameter, i.e. whether the second specific time interval is greater or less than the first of the two transmitted interrogation signals.

To exactly specify which control command the vehicle control device outputs, said device may use one of the further parameters mentioned, or a specific combination of these.

For example, the criteria for outputting a lock command may be as follows. A first criterion is the detection of a change in the specific time intervals for two transmitted interrogation signals greater than the predetermined threshold value. A further criterion may be the presence of a signal from the locking sensor that represents an unlocked state of the at least one door of the vehicle, and/or if the specific time interval for the second of the two transmitted interrogation signals is longer than the specific time interval for the first of the two transmitted interrogation signals, and/or if at least one of the specific time intervals for the two transmitted interrogation signals exceeds a second predetermined threshold value (and thus the distance between the vehicle and the mobile identification transmitter), and/or if the door sensor has detected opening, or opening and closing, of at least one door of the vehicle in a predetermined time period before the transmission of the first and second of the two transmitted interrogation signals.

Furthermore, for example the criteria for outputting an unlock command may be as follows. A first criterion is the detection of a change in the specific time intervals for two transmitted interrogation signals greater than the predetermined threshold value. A further criterion may be the presence of a signal from the locking sensor that represents a locked state of the at least one door of the vehicle, and/or if the specific time interval for the second of the two transmitted interrogation signals is shorter than the specific time interval for the first of the two transmitted interrogation signals, and/or if at least one of the specific time intervals for the two transmitted interrogation signals falls short of or is equal to a second predetermined threshold value (and thus the distance between the vehicle and the mobile identification transmitter), and/or if the door sensor has not detected opening, or opening and closing, of at least one door of the vehicle in a predetermined time period before the transmission of the first and second of the two transmitted interrogation signals.

According to a further configuration, it is also conceivable, when a static situation is recognized, to include further parameters in order to bring about goal-oriented output of a suitable control command.

The vehicle control device may thus be configured to use a detected change in the specific time intervals for two transmitted interrogation signals less than or equal to the predetermined threshold value as a first criterion, and the fact that at least one of the specific time intervals for the two transmitted interrogation signals is less than or equal to a time threshold value (and thus the mobile identification transmitter is less than or equal to a predetermined distance away from the vehicle control device) as a second criterion, in order to output a start command for a drive motor of the vehicle.

Further, the vehicle control device may be configured to use a detected change in the specific time intervals for two transmitted interrogation signals less than or equal to the predetermined threshold value as a first criterion, and the fact that at least one of the specific time intervals for the two transmitted interrogation signals is greater than a time threshold value (and thus the mobile is greater than a predetermined distance away from the vehicle control device) as a second criterion, in order to output a deactivate command for deactivating the access and/or start function.

According to a further configuration, the mobile identification transmitter has a sensor for measuring a physical parameter, wherein the vehicle control device further outputs the control command on the basis of the physical parameter measured by the mobile identification transmitter. For example, the sensor of the mobile identification transmitter may comprise a motion sensor for detecting a movement/acceleration, a compass for detecting the earth's magnetic field, and/or a sensor for detecting GPS signals for determining location.

It is conceivable for the mobile identification transmitter to be a mobile identification transmitter in the form of an electronic key for the vehicle, or else in the form of a smartphone, a smartwatch, or any other wearable (“wearable device”) that a driver, or user, of the vehicle may carry.

According to a further aspect of the invention, a vehicle having an access arrangement according to a representation above or a configuration thereof is provided. This further improves the security and comfort of the vehicle.

According to a further aspect of the invention, a method for operating an access arrangement for a vehicle is provided, which has the following steps. The vehicle transmits multiple interrogation signals to a mobile identification transmitter. In particular, the interrogation signals are transmitted one after the other. Furthermore, corresponding response signals are received from the mobile identification transmitter in response to the transmitted interrogation signals. In addition, a respective time interval that has elapsed between the transmission of an interrogation signal and the reception of a corresponding response signal is determined. Finally, the vehicle outputs a different control command on the basis of a change in the specific time intervals for two transmitted interrogation signals.

The interrogation signals and response signals are transmitted in particular according to the UWB standard.

Advantageous configurations of the access arrangement, insofar as they may be applied to the vehicle and the method, can also be regarded as advantageous configurations of the vehicle and the method, and vice versa.

### DESCRIPTION

Illustrative embodiments of the present invention will now be explained in greater detail below with reference to the accompanying drawings, in which:

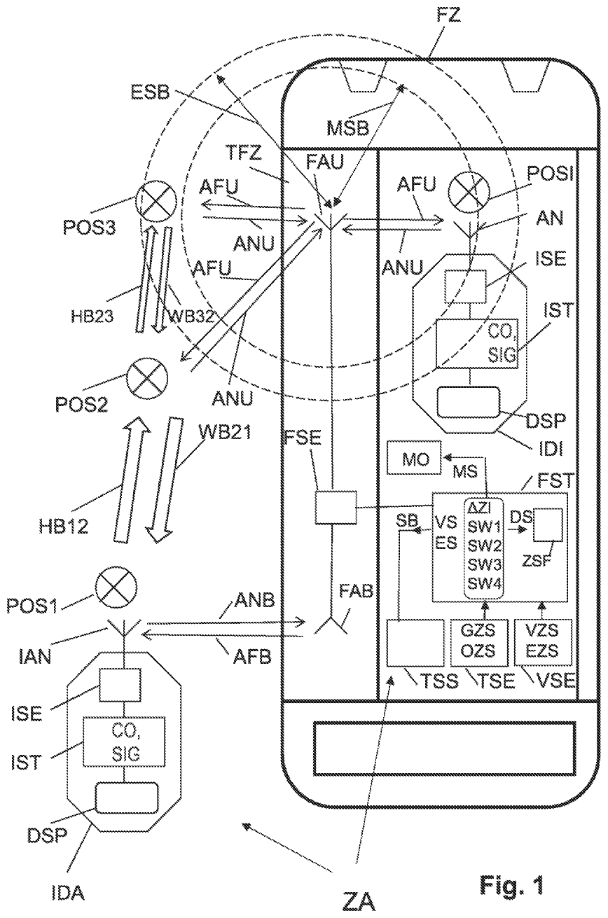

FIG. 1 shows a schematic representation of an access arrangement for a vehicle according to an embodiment of the invention;

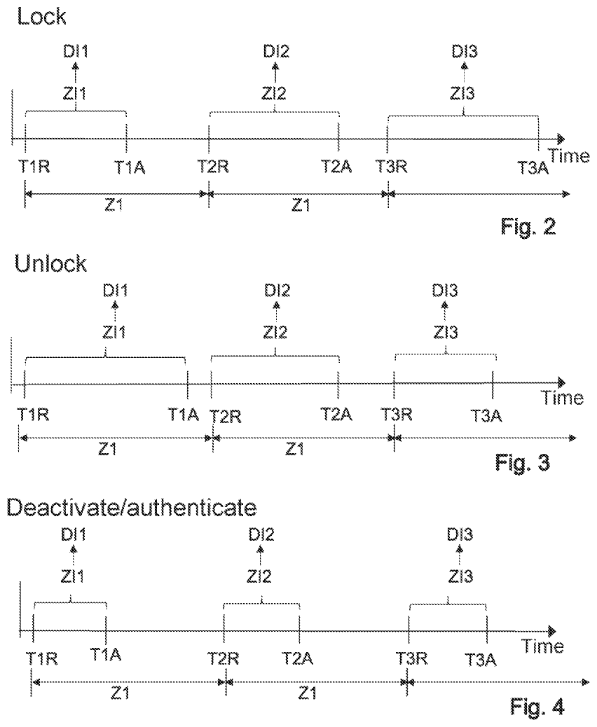

FIG. 2 shows a time sequence for the sending and receiving of UWB signals by the vehicle to explain automatic locking of the vehicle;

FIG. 3 shows a time sequence for the sending and receiving of UWB signals by the vehicle to explain automatic unlocking of the vehicle;

FIG. 4 shows a time sequence for the sending and receiving of UWB signals by the vehicle in a static situation with regard to a portable identification transmitter.

Reference will first be made to FIG. 1, which shows a passive electronic access arrangement ZA for a vehicle FZ, which is in the form of a motor vehicle. There is provision for a vehicle transmission/reception device FSE as a central component of the vehicle part of the access arrangement ZA. Said device is able to transmit, and receive, two different types of signals. Firstly, it is designed to transmit chronologically successive interrogation signals regularly at predetermined time intervals via a vehicle antenna FAB. In this case, the interrogation signals AFB are transmitted by the antenna FAB in particular at the same, or constant, transmission field strength. These interrogation signals AFB are used to recognize a mobile identification transmitter as a mobile part of the access arrangement ZA when said transmitter approaches the vehicle, in order to trigger a question-and-answer dialog that may be used to perform a preauthentication or an authentication of the mobile identification transmitter to the vehicle.

In this example, a mobile identification transmitter is supposed to be in the form of a smartphone that has firstly a user interface DSP for a driver, or user, and also the applicable radio and control components, as described below.

If for example such an identification transmitter IDA approaches the vehicle FZ, it will, when it has come into a detection range of the interrogation signals AFB (when it is within a certain distance of the vehicle), receive the interrogation signals AFB by means of an identification-transmitter antenna IAN and forward them to an identification-transmitter transmission/reception device ISE. For a (pre)authentication process, the identification transmitter IDA is able to read a code CO from a memory of an identification-transmitter control device IST, so that said code is returned to the vehicle, i.e. to the antenna FAB, via the identification-transmitter transmission/reception device ISE and the identification-transmitter antenna IAN as part of a response signal ANB.

The question-and-answer dialog using the signals AFB and ANB can take place in accordance with a Bluetooth standard, and in particular in accordance with the Bluetooth Low Energy (BLE) standard, in order to ensure power-saving communication in this way.

When the mobile identification transmitter IDA makes this initial contact with the vehicle FZ, it is still at a position POS1 that is still too far away from the vehicle to trigger an unlocking process for a door TFZ of the vehicle FZ. To do this, the identification transmitter needs to get even closer to the vehicle.

If the code transmitted from the mobile identification transmitter IDA to the vehicle FZ corresponds to a specified code that is stored in particular in a memory device (not shown) of a vehicle control device FST, then the mobile identification transmitter IDA has performed at least one first authentication process positively. On the basis of this positive authentication process, the vehicle control device FST tells the vehicle transmission/reception device FSE to start precisely locating or localizing (ranging) the mobile identification transmitter IDA on its way to the vehicle.

It is now assumed that the mobile identification transmitter IDA moves from its first position POS1 along the arrow HB12 in the direction of the second position POS2, and thus closer to the vehicle. Meanwhile, the vehicle transmission/reception device FSE will use a further section to start locating, in particular in the simple case determining the distance of the mobile identification transmitter IDA from the vehicle FZ. For this purpose, further interrogation signals AFU are transmitted by the vehicle via an antenna FAU at further regular time intervals. These further interrogation signals AFU are sent, in particular in accordance with a UWB (ultra-wideband) standard, with the aim of being able to perform precise determination of the distance between the mobile identification transmitter IDA and the vehicle FZ (more specifically the antenna FAU thereof) by measuring the time of flight.

If the mobile identification transmitter IDA is now at the position POS2 and is within the detection range of the interrogation signals AFU, it will use its antenna IAN (or a separate UWB antenna) to receive the signal and forward it to the identification-transmitter transmission/reception device ISE. This is then able to use a signature SIG stored in a memory of the identification-transmitter control device IST to return a corresponding response signal ANU, again in the form of a UWB signal, to the vehicle UWB antenna FAU. The time between the sending of the interrogation signal AFU and the reception of the response signal ANU may then be calculated either in the vehicle transmission/reception device FSE or in the vehicle control device FST. Advantageously, the envisaged time that the mobile identification transmitter needs for processing the interrogation signal AFU and generating the response signal ANU provided with the signature SIG is then subtracted, and the vehicle control device is able to use the thus “cleaned-up” period of time to deduce the distance that the mobile identification transmitter IDA is away from the UWB antenna FAU. If there were provision for multiple UWB antennas on the vehicle FZ (not shown), it would thus be possible to use triangulation to ascertain not only a distance between the mobile identification transmitter and the vehicle FZ but also its precise position.

It is now further assumed that the mobile identification transmitter IDA continues to be in a dynamic situation in which it is approaching the vehicle and is moving from the position POS2 in the direction of arrow HB23 to the position POS3. In this position POS3 too, the mobile identification transmitter IDA receives interrogation signals AFU from the vehicle UWB antenna FAU, in order to then respond to them with an applicable signature SIG as part of response signals ANU. With each question-and-answer dialog ANU, the vehicle transmission/reception device FSE or in particular the downstream vehicle control device FST will measure the time of flight of the signals and accordingly be able to use this to determine the distance between the positions of the mobile identification transmitter and the antenna FAU.

In particular, the vehicle control device FST is thus able to determine whether the mobile identification transmitter IDA is within an unlocking range, which defines a spatial area that has a maximum distance between a radius ESB and the vehicle UWB antenna FAU. Furthermore, the vehicle control device FST is able to determine whether the mobile identification transmitter is located within an engine start range, which represents a spatial area around the vehicle UWB antenna FAU that has a maximum radius or distance MSB. The radius MSB is smaller than the radius ISB.

As is shown on the right-hand side of FIG. 1, it may also happen that the mobile identification transmitter is located inside the vehicle FZ. Such an identification transmitter is then referred to as a mobile identification transmitter IDI and may be either identical to the identification transmitter outside the vehicle FZ or separate, in which case it has the same components as the mobile identification transmitter IDA outside the vehicle FZ. A mobile identification transmitter IDI may also be localized by way of a question-and-answer dialog, which is initiated by the transmission of a signal AFU and is concluded by the reception of a signed response signal ANU. The vehicle control device FST is thus able to identify that, as shown in the representation in FIG. 1, the mobile identification transmitter IDI is at the position POSI, which is within the engine start range. If the mobile identification transmitter IDI is located at the position POSI for example permanently in an envisaged rack, then the mobile identification transmitter is in a static situation.

It is conceivable in this static situation for the vehicle control device FST to take the change ΔZI in two measured time intervals less than a first threshold value SW1, and possibly other conditions, as a basis for outputting a deactivate command DS to an access and start unit ZSF for deactivating the access and start function, or accordingly to output an engine start command MS, in order for example to deactivate an immobilizer, and thus to start a drive motor MO.

For the description of the invention that follows, the other vehicle components connected to the vehicle control device FST will also be explained. These include a central locking system TSS for locking, or unlocking, the vehicle door TFZ, a door sensor TSE for sensing an open or closed state of at least one door of the vehicle (such as the door TFZ), and a locking sensor VSE for sensing an unlocked or locked state of at least one door of the vehicle, such as the door TFZ. It is conceivable for the vehicle control device FST to be able to send a control command SB that contains either a lock command VS or an unlock command ES to the central locking system TSS. The door sensor TSE is designed to forward the open OZS or closed GZS state of the door TFZ to the vehicle control device FST. Accordingly, the locking sensor VSE is configured to send sensor data, such as the locked state VZS or the unlocked state EZS of the vehicle door, to the vehicle control device FST.

Reference will now be made to FIG. 2, which shows a time sequence to illustrate an automatic locking process according to an embodiment of the invention. It is assumed here that, as mentioned in FIG. 1, a mobile identification transmitter, for example at the position POS3, has already gone through a positive authentication process by way of a question-and-answer dialog using the signals AFB and ANB, and the vehicle control device is in localization mode, or locating mode. In this mode, it regularly transmits interrogation signals AFU in the first time intervals Z1. It is now assumed that the mobile identification transmitter IDA moves away from the vehicle FZ, for example from the position POS3 along the arrow WB32 to the position POS2 and from there along the arrow WB21 to the position POS1.

For the time sequence of FIG. 2, this means that the vehicle transmission/reception device FSE transmits a signal to the mobile identification transmitter IDA at the time T1R, said transmitter being at the position POS3 close to the vehicle at this time. Accordingly, the interrogation signals AFU and the corresponding response signal ANU will each have a short time of flight, and so the vehicle transmission/reception device FSE receives the response signal ANU within a short time interval ZI1 at the time T1A. The short time interval ZI1 more or less represents a short distance DI1 between the mobile identification transmitter and the vehicle.

Then, at the time T2R, the vehicle transmission/reception device FSE transmits a further interrogation signal AFU to the mobile identification transmitter IDA, which is already at the position POS2 (because the driver, who is carrying the mobile identification transmitter, has moved away). Since this position is further away from the vehicle FZ than the position POS3, the time of flight of the applicable interrogation and response signals will also be longer, and so the time interval ZI2 up to the time T2A, reception of the second response signal, is longer than the time interval ZI1. Accordingly, a greater distance DI2 is also identified due to the longer time of flight.

At the time T3R, the vehicle transmission/reception device transmits a further interrogation signal to the mobile identification transmitter IDA, which has already moved further away from the vehicle and for example is located at the position POS1. The mobile identification transmitter IDA signs this interrogation signal AFU and returns a response signal ANU, which the vehicle transmission/reception device FSE receives at the time T3A. This third time interval ZI3 is now longer than the second time interval ZI2, and so the distance DI3 between the mobile identification transmitter IDA and the vehicle FZ that is identified as a result is also greater than the ascertained distance DI2.

The vehicle control device FST can now use these ascertained time intervals to perform specific control processes on the above-mentioned vehicle components. In the simplest case, the vehicle control device FST is able to check whether a change ΔZI that is greater than a predetermined threshold value SW1 has occurred between the ascertained time intervals ZI1, ZI2 and/or ZI3. For example, it is possible to check whether the difference ZI2−ZI1 is greater than the threshold value SW1, or whether the difference ZI3−ZI2 is greater than the threshold value SW1. If the respective difference is greater than the threshold value, this may be referred to as a dynamic situation in which the mobile identification transmitter IDA is moving. Movement may be a movement towards the vehicle or away from the vehicle. Assuming the simplest case, the vehicle control device FST is able to output a lock command whenever it has identified a change in two measured time intervals greater than the threshold value SW1 based on the transmission of at least two interrogation signals AFU in succession.

However, it is also conceivable to use one or more further criteria for outputting a control command SB to the central locking system TSS. For example, following determination of the difference between two measured time intervals greater than the first threshold value SW1, it is also possible to check whether one or both of the time intervals used for calculating the difference is greater than an absolute time threshold value SW2. This time threshold value again represents a certain distance between the vehicle and the mobile identification transmitter. If the first step thus identifies that the situation is dynamic, with ΔZI being greater than SW1, and also a time interval used for calculating the difference is greater than an absolute threshold value SW2, none of the time intervals used for the preceding difference calculations (e.g. for calculating the difference ZI2−ZI1) in particular having been greater than the second threshold value SW2, then it is identified that the driver is walking away from the vehicle and therefore that the mobile identification transmitter being carried is moving away. These criteria according to the steps shown may then cause the vehicle control device FST to output a control command SB in the form of a lock signal VS to the central locking system so that it locks all the doors of the vehicle.

Reference will now be made to FIG. 3, which shows the case of unlocking a vehicle. In this instance, the vehicle transmission/reception device FSE transmits interrogation signals AFU at the times T1R, T2R and T3R at first predetermined time intervals Z1, said signals being transmitted by the mobile identification transmitter IDA, which is meanwhile moving, for example, from the position POSI at the time T1R through the position POS2 at the time T2R to the position POS3 at the time T3R. Due to the movement towards the vehicle FZ, or towards the vehicle UWB antenna FAU, the times of flight shorten from the longest time of flight ZI1 through the average time of flight ZI2 to the shortest time of flight ZI3, since the position POS3 is closest to the vehicle FZ. Accordingly, the distances DI1, DI2 and DI3 ascertained using the times of flight ZI1, ZI2 and ZI3 also become shorter.

If differences between the measured time intervals ZI1−ZI2 and ZI2−ZI3 are again calculated, these will all be greater than the threshold value SW1, as a result of which a dynamic situation is recognized. In the simplest case, it would also be possible to stipulate here that when a dynamic situation is recognized, an unlock command ES is output as a control command SB from the vehicle control device FST to the central locking system TSS (instead of the lock command VS mentioned in relation to FIG. 2).

However, it is conceivable to use further criteria for outputting an unlock command ES here as well. It would thus be conceivable to check whether, in a dynamic situation, one of the time intervals used for calculating the difference or both time intervals used (such as the time intervals ZI2 or ZI3) is less than a predetermined further absolute time threshold value SW3. This means that the intention here is to check whether the time of flight of corresponding UWB signals AFU and ANU is shorter than a predetermined time, and the mobile identification transmitter is therefore within a certain distance of the vehicle FZ. Such a distance has, of course, already been stipulated, for example, by the radius ESB for defining the unlocking range, see FIG. 1. Thus, following determination of a dynamic situation and the fact that at least one of the time intervals used for calculating the difference is less than a further predetermined time threshold value SW3 (and the mobile identification transmitter is therefore in an unlocking range), an unlock signal ES may be output as a control command SB to the central locking system TSS, in particular if the time intervals previously checked and used for calculating the difference, or at least one of said time intervals, were always greater than the further time threshold value SW3.

Finally, reference will be made to FIG. 4, which shows a static situation. As already mentioned in the two figures above, the vehicle transmission/reception device FSE will transmit interrogation signals AFU in first predetermined time intervals Z1 at the times T1R, T2R and T3R. However, it will now be assumed that the mobile identification transmitter is not moving but is located close to the vehicle UWB antenna FAU. For example, it may be stored in a special rack. This rack may be arranged in a position POSI that, due to its short distance, is within the engine start range defined by the radius MSB.

Since the mobile identification transmitter IDI does not move in the rack, the measured time intervals ZI1, ZI2 and ZI3 will be almost identical, and thus a difference between ZI1−ZI2 or ZI2−ZI3 will be less than the predetermined threshold value SW1. In the simplest case, it would now be possible to specify that the vehicle control device FST automatically initiates a further authentication process on recognizing a static situation, in order to deactivate an immobilizer, or to output an engine start signal MS to the drive motor MO, if the outcome is positive.

Here too, however, it is conceivable to again take account of one or more additional criteria for outputting a differentiated control command. After the static situation has been identified, it is thus also possible to check whether one or all of the time intervals ZI1, ZI2 or ZI3 used to calculate the difference are less than a specific further time threshold value SW4. In this case, the time threshold value SW4 may be less than the time threshold value SW3. Furthermore, the time threshold value SW4 may for example correlate with the radius MSB that defines the engine start range, so that if the mobile identification transmitter is in the engine start range, a time of flight of the UWB signals AFU and ANU that is less than the threshold value SW4 is achieved. This would apply to a mobile identification transmitter IDI that is located in the rack at the position POSI.

If, on the other hand, a static situation is identified in a first step and then all the time intervals ZI1 to ZI3 are identified as being greater than the predetermined threshold value SW4, it may be assumed that the applicable mobile identification transmitter was probably inadvertently lost, or forgotten, in the vehicle or close to the vehicle. Accordingly, the vehicle control device FST is able to send a deactivate signal DS to the access/start device ZSF in this case in order to deactivate the applicable access and/or start function on the vehicle.

Besides the special evaluation of the measured time-of-flight intervals ZI1 to ZI3 and the applicable differences therefrom for differentiated control of vehicle components, it is also conceivable to factor the above-mentioned sensors, such as the door sensor TSE or the locking sensor VSE, into the decision as to which control command is to be output. It is thus conceivable, when a dynamic case is identified (time-of-flight difference calculation ΔZI greater than the first predetermined threshold value SW1), to check which state the locking sensor VSE is outputting. If it is outputting a locked state VZS, an unlock command ES may be output automatically when a dynamic situation is recognized, while a lock command may be output automatically when an unlocked state EZS is present.

It is moreover conceivable for the vehicle control device FST to first detect opening of a vehicle door and then closing of the vehicle door by way of the door sensor TSW within a predetermined period of time, this then being followed by a change, or difference, in applicable times of flight (time-of-flight difference calculation) ΔZI greater than the first threshold value SW1 after multiple interrogation signals AFU have been transmitted. The presence of these criteria suggests that the driver gets out of his vehicle FZ and moves away from it. Accordingly, the presence of these criteria may be used to output an automatic lock command.

Finally, it will be noted that measuring the time of flight of the signals AFU and ANU as part of a question-and-answer dialog allows precise location or distance measurement to be performed, and so the security of the access arrangement is increased and radio link extensions as part of a so-called middleman attack (“relay attack”) can no longer be performed.

Moreover, monitoring the change in the time intervals for in each case two transmitted interrogation signals makes it possible to react to different situations for the mobile identification transmitter, and the vehicle control device is accordingly able to output the appropriate control command. This monitoring may be performed with minimized equipment outlay, since, as in the case explained in FIG. 1, this monitoring of the change in the time intervals, or of the change in the distances between the vehicle and the mobile identification transmitter, may, in the simplest case, be carried out with only one vehicle transmission/reception device and one identification-transmitter transmission/reception device, and is therefore very cheap.

1. An access arrangement for a vehicle, comprising:
a vehicle transmission/reception device configured to:
transmit multiple interrogation signals to a mobile identification transmitter,
receive corresponding response signals from the mobile identification transmitter in response to the transmitted interrogation signals, and
determine a respective time interval that elapsed between the transmission of an interrogation signal and the reception of a corresponding response signal; and
a vehicle control device configured to output a different control command based on a change in specific time intervals for two transmitted interrogation signals.

2. The access arrangement as claimed in claim 1, wherein the interrogation signals and response signals are signals in accordance with UWB standard.

3. The access arrangement as claimed in claim 1, wherein the vehicle control device is configured to at least one of:
output at least one first control command when a change in the specific time intervals for two transmitted interrogation signals is less than or equal to a predetermined threshold value, and
at least one second control command when a change in the specific time intervals for two transmitted interrogation signals is greater than a predetermined threshold value.

4. The access arrangement as claimed in claim 1, wherein the vehicle control device further outputs the control command based on a signal from a door sensor configured to sense an open or closed state of at least one door of the vehicle and/or a signal from a locking sensor configured to sense an unlocked or locked state of at least one door of the vehicle.

5. The access arrangement as claimed in claim 4, wherein the vehicle control device outputs an unlock command for the at least one door of the vehicle as at least one second control command:
when a change in the specific time intervals for two transmitted interrogation signals greater than a predetermined threshold value is detected, or
either when there is a signal from the locking sensor that represents a locked state of the at least one door of the vehicle or when a specific time interval for the second of the two transmitted interrogation signals is shorter than a specific time interval for the first of the two transmitted interrogation signals.

6. The access arrangement as claimed in claim 4, wherein the vehicle control device outputs a lock command for the at least one door of the vehicle as at least one further second control command:
when a change in the specific time intervals for two transmitted interrogation signals greater than a predetermined threshold value is detected, or
either when there is a signal from the locking sensor that represents an unlocked state of the at least one door of the vehicle or if a specific time interval for the second of the two transmitted interrogation signals is longer than a specific time interval for the first of the two transmitted interrogation signals.

7. The access arrangement as claimed in claim 1, wherein the vehicle control device further outputs the control command based on at least one of the specific time intervals for the two transmitted interrogation signals.

8. The access arrangement as claimed in claim 7, wherein the vehicle control device is configured to output a start command for a drive motor of the vehicle as at least one first control command:
when a change in the specific time intervals for two transmitted interrogation signals less than or equal to a predetermined threshold value is detected, or
if at least one of the specific time intervals for the two transmitted interrogation signals is less than or equal to a time threshold value.

9. The access arrangement as claimed in claim 7, wherein the vehicle control device is configured to output a deactivate command for deactivating access and/or start function as at least one further first control command:
when a change in the specific time intervals for two transmitted interrogation signals less than or equal to a predetermined threshold value is detected, or
if at least one of the specific time intervals for the two transmitted interrogation signals is greater than a time threshold value.

10. The access arrangement as claimed in claim 1,
which further comprises a mobile identification transmitter with a sensor configured to measure a physical parameter,
wherein the vehicle control device further outputs the control command based on the physical parameter measured by the mobile identification transmitter.

11. The vehicle having the access arrangement as claimed in claim 1.

12. A method for operating an access arrangement for a vehicle, comprising the steps of:
at the vehicle, transmitting multiple interrogation signals to a mobile identification transmitter,
receiving corresponding response signals from the mobile identification transmitter in response to the transmitted interrogation signals,
determining a respective time interval that elapsed between the transmission of an interrogation signal and the reception of a corresponding response signal; and
at the vehicle, outputting a different control command based on a change in the specific time intervals for two transmitted interrogation signals.

13. The method as claimed in claim 12, wherein the interrogation signals and response signals are signals in accordance with UWB standard.

14. The access arrangement as claimed in claim 2, wherein the vehicle control device is configured to at least one of:
output at least one first control command when a change in the specific time intervals for two transmitted interrogation signals is less than or equal to a predetermined threshold value, and
output at least one second control command when a change in the specific time intervals for two transmitted interrogation signals is greater than a predetermined threshold value.

15. The access arrangement as claimed in claim 2, wherein the vehicle control device further outputs the control command based on a signal from a door sensor configured to sense an open or closed state of at least one door of the vehicle and/or a signal from a locking sensor configured to sense an unlocked or locked state of at least one door of the vehicle.

16. The access arrangement as claimed in claim 2, wherein the vehicle control device further outputs the control command based on at least one of the specific time intervals for the two transmitted interrogation signals.

17. The access arrangement as claimed in claim 3, wherein the vehicle control device further outputs the control command based on a signal from a door sensor configured to sense an open or closed state of at least one door of the vehicle and/or a signal from a locking sensor configured to sense an unlocked or locked state of at least one door of the vehicle.

18. The access arrangement as claimed in claim 3, wherein the vehicle control device further outputs the control command based on at least one of the specific time intervals for the two transmitted interrogation signals.

19. The access arrangement as claimed in claim 4, wherein the vehicle control device further outputs the control command based on at least one of the specific time intervals for the two transmitted interrogation signals.

20. The access arrangement as claimed in claim 5, wherein the vehicle control device outputs a lock command for the at least one door of the vehicle as at least one further second control command:
when a change in the specific time intervals for two transmitted interrogation signals greater than the predetermined threshold value is detected, or
either when there is a signal from the locking sensor that represents an unlocked state of the at least one door of the vehicle or if the specific time interval for the second of the two transmitted interrogation signals is longer than the specific time interval for the first of the two transmitted interrogation signals.
